(19) United States
(12) Patent Application Publication
(10) Pub. No.: US 2026/0099470 A1
(43) Pub. Date: Apr. 9, 2026

(54) PATH-BASED ACTIVE HYDRATION OF FILES WITH NO PLACEHOLDER ON DISK

(71) Applicant: Microsoft Technology Licensing, LLC, Redmond, WA (US)

(72) Inventors: Brian David JONES, Woodinville, WA (US); Hardik Rajiv SHAH, Redmond, WA (US)

(73) Assignee: Microsoft Technology Licensing, LLC, Redmond, WA (US)

(21) Appl. No.: 18/905,264

(22) Filed: Oct. 3, 2024

(51) Int. Cl. G06F 16/182; G06F 16/14; G06F 16/16

(52) U.S. Cl. CPC G06F 16/183; G06F 16/148; G06F 16/166

(57) ABSTRACT

A data processing system implements receiving, at a file system filter, a request to access a file information associated with a file from a requesting application on a user device; determining that neither a copy of the file or a placeholder file are available on the user device; accessing file mapping information from a file mapping datastore to determine whether a path associated with the file is within a namespace under control of the cloud file provider, the filename information, or both the path information and the filename information associated with the files; obtaining content associated with the file from the cloud file provider based on the file mapping information responsive to the path associated with the file being within the namespace under control of the cloud file provider; and providing the content associated with the file to the requesting application.

### BACKGROUND

Cloud file providers enable users to store and protect their files in cloud-based storage, share their files with others, and to access their files from the cloud-based storage on multiple user devices. The file systems on these devices provide file system filters that enable cloud file providers to register with the file system filters to enable the cloud service providers. This enables the file system filters to fulfill requests from applications attempting to read a file that is not available locally on the user device but is available in the cloud storage provided by the cloud file provider. In such implementations, a placeholder file is maintained on the user device. The placeholder file includes file metadata and may include other information, such as but not limited to thumbnail representations of images included in the document where applicable. The file system filters can use this metadata information to submit a content hydration request to the cloud file provider to cause the cloud file provider to provide the contents of the file and/or file metadata to the user device. If the placeholder file is moved, deleted, or is otherwise unavailable on the user device, the file system filter is unable to obtain the file content from the cloud file provider and the application requesting the file is informed that the file cannot be located. Hence, there is a need for improved systems and methods that provide means for completing requests for file content from a cloud file provider where a placeholder file cannot be located on the user device.

### SUMMARY

An example data processing system according to the disclosure includes a processor and a memory storing executable instructions. The instructions when executed cause the processor alone or in combination with other processors to perform operations including receiving, at a file system filter, a request to access a file information associated with a file from a requesting application on a user device; determining, using the file system filter, that neither a copy of the file or a placeholder file are available on the user device, the placeholder file indicating how a copy of the file can be obtained from a cloud file provider; accessing, using a file provider client, file mapping information from a file mapping datastore to determine whether a path associated with the file is within a namespace under control of the cloud file provider, the file mapping information including path information and filename information for files within the namespace and changes to the path information, the filename information, or both the path information and the filename information associated with the files; obtaining, using the file provider client, content associated with the file from the cloud file provider based on the file mapping information associated with the namespace responsive to the path associated with the file being within the namespace under control of the cloud file provider; and providing the content associated with the file to the requesting application.

An example data processing system according to the disclosure includes a processor and a memory storing executable instructions. The instructions when executed cause the processor alone or in combination with other processors to perform operations including receiving, at a file system filter, a first search request from a requesting application on a user device comprising query parameters for identifying relevant files stored on the user device or on a cloud file provider; searching, using a file provider client, for relevant files stored on the user device based on the query parameters to obtain first search results; submitting, using the file provider client, a second search request to the cloud file provider for relevant files stored on the cloud file provider; receiving second search results from the cloud file provider, the second search results including information identifying a plurality of files stored on the cloud file provider determined to be relevant based on the query parameters; determining, using the file system filter, that neither a copy nor a placeholder file associated with one or more files of the plurality of files stored on the cloud file provider are available on the user device; generating a placeholder file for the one or more files indicating where the one or more files can be obtained from the cloud file provider; and providing the first search results and the second search results to the requesting application.

An example data processing system according to the disclosure includes a processor and a memory storing executable instructions. The instructions when executed cause the processor alone or in combination with other processors to perform operations including receiving, at a file system filter, a first request to generate content from a requesting application on a user device; generating a placeholder file for the content in memory of the user device; providing, using a file provider client, a second request to generate the content to a cloud file provider in response to receiving the first request; receiving file metadata from the cloud file provider indicating that the cloud file provider has created the content and stored the content in a file storage memory of the cloud file provider; updating the placeholder file on the user device based on the file metadata, the file metadata including information for obtaining the content from the cloud file provider; and providing an indication to the requesting application that the content has been created.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A, 1B, and 1C are diagrams of an example computing environment in which the techniques for fulfilling requests for files stored on a cloud file provider for which no placeholder file is present described herein are implemented.

FIGS. 2A, 2B, 2C, and 2D are diagrams of an example computing environment in which the techniques for fulfilling a request to generate content described herein are implemented.

FIGS. 3A and 3B are diagrams of an example computing environment in which the techniques for fulfilling a search request for content stored on the cloud file provider or both the user device and the cloud file provider described herein are implemented.

FIGS. 4A and 4B are diagrams of an example computing environment in which the techniques for fulfilling requests for files cached on a user device described herein are implemented.

FIG. 5A is a flow chart of an example process for processing requests for files from an application on a user device according to the techniques disclosed herein.

FIG. 5B is a flow chart of another example process for processing requests for files from an application on a user device according to the techniques disclosed herein.

FIG. 5C is a flow chart of another example process for processing requests for files from an application on a user device according to the techniques disclosed herein.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

Systems and methods for path-based active hydration of files with no placeholder on disk are provided. These techniques address the technical problems associated with current cloud file providers, which require a placeholder file be on the disk of the user device in order to obtain hydrated versions of files from the cloud file provider. The placeholder files on the user device do not include the file contents and/or metadata. Instead, the placeholder files provide information that enable the cloud file provider to be able to fulfill requests from applications attempting to read a file that is not available locally on the user device but is available in the cloud storage provided by the cloud file provider. The placeholder file can include metadata and/or other information. The cloud provider can use the information in the placeholder file to identify an instance of the file stored on the cloud file provider. The cloud file provider can provide at least a portion of the file content and/or metadata associated with this instance to the user device in response to a hydration request to replace the placeholder file with an instance of the file that includes file content and/or metadata. However, these placeholder files can be moved, renamed, deleted, or otherwise become unavailable on the user device. Consequently, an application attempting to access the file will receive a file not found error in current system.

The techniques herein address this problem by providing a file system filter that monitors input/output operations on the file system of the user device and communicates with a file provider client implemented on the user device that maintains a mapping of the files on the user device within a namespace controlled by the file provider client. The file provider client exposes this namespace to the file system filter. Consequently, if an application requests access to a file that the file system filter cannot locate in the file system of the user device, the file system filter can determine whether the requested file falls within the namespace maintained by the file provider client and request the file or placeholder file from the file provider client if the requested file falls within this namespace.

The file provider client utilizes the placeholder files to fulfill hydration requests for content stored on the cloud file provider. The file provider client monitors when placeholder files are moved and/or renamed within this namespace and maintains a mapping between the original file path and/or filename and the new file path and/or filename of the placeholder files and can recreate the placeholder file using this file mapping information so that the file provider client can fulfill hydration requests. The file provider client can also recreate placeholder files that have been deleted as a result of a file cleanup or other such processes to reallocate storage on the user device to enable the file provider client fulfil requests to hydrate a file. A technical benefit of this approach is that the file system filter can support requests for files from the application where the application is unaware that the file has been moved, renamed, or removed but the file contents can be obtained from the cloud file provider.

The techniques herein can also be used to facilitate the creation of content using artificial intelligence and/or procedural generation means. The creation of the content by the one or more generative models and/or through procedural means may take a significant amount of time. A technical benefit of the techniques herein is that the file system filter can be used to generate a placeholder file for the content being created by the cloud file provider while this content is being created and placeholder file is then hydrated with the generated content once the content had been created.

The techniques herein can also be used to facilitate searches for files that are stored on the user device and/or the cloud file provider. The file provider client creates placeholder files for files that are included in the search results from the cloud file provider rather than automatically creating instances of these files on the user device. A technical benefit of this approach is that the search results can be rapidly provided to the application requesting the search results to avoid delaying the presentation of the search results. The files system filter can then request that the file provider client selectively hydrate files from the search results to reduce the network and computing resources that would otherwise be required to hydrate all of the files in the search results. These and other technical benefits of the techniques disclosed herein will be evident from the discussion of the example implementations that follow.

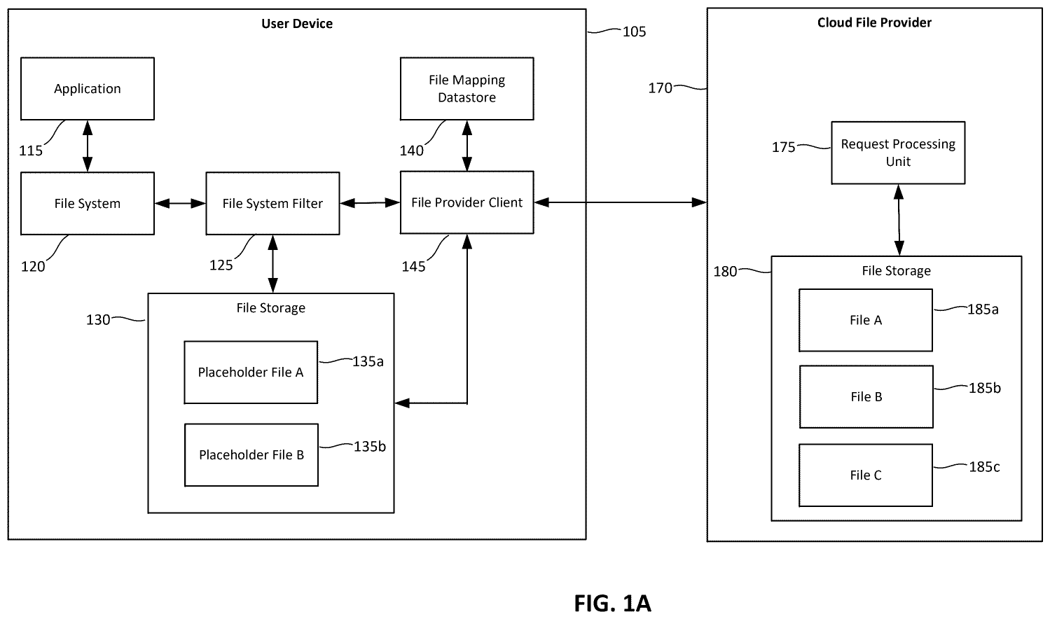

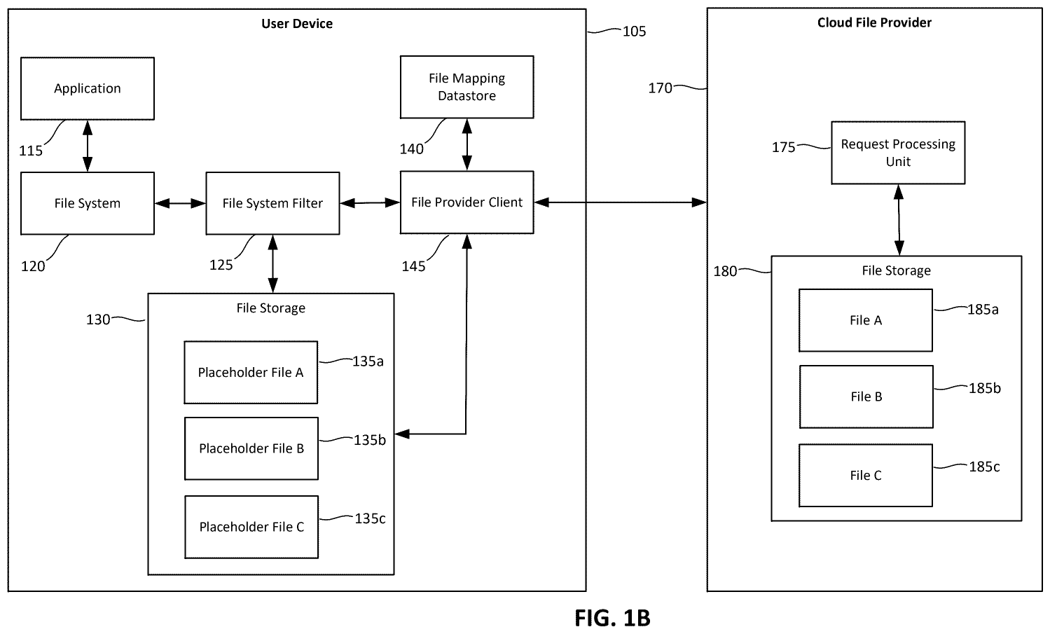

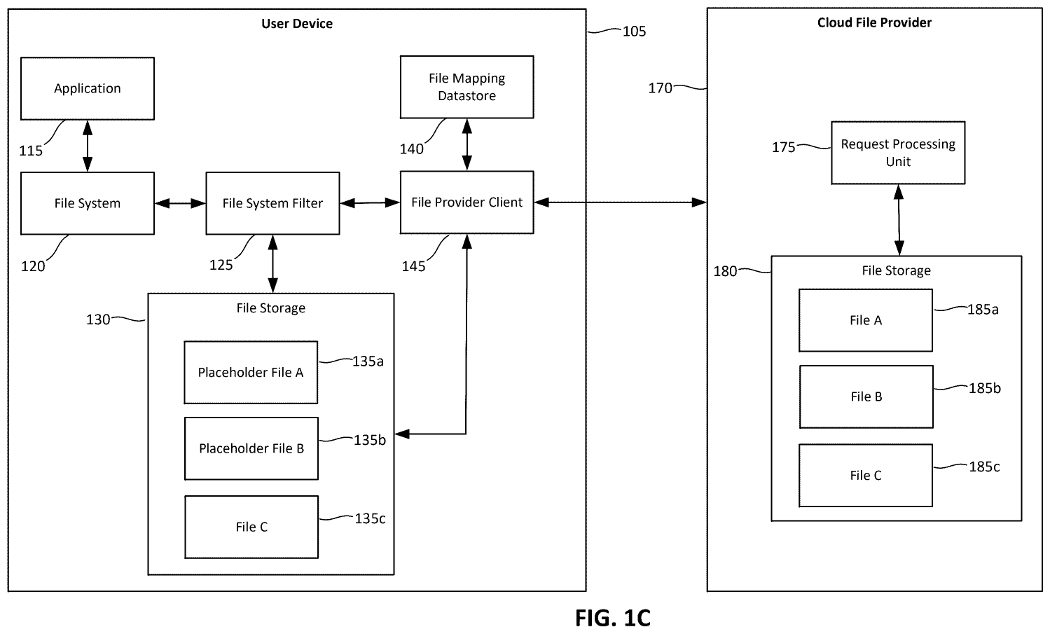

FIGS. 1A, 1B, and 1C are diagrams of an example computing environment in which the techniques for fulfilling requests for files stored on a cloud file provider for which no placeholder file is present described herein are implemented. The example computing environment shown in FIGS. 1A, 1B, and 1C includes a user device 105 and a cloud file provider 170. While the example implementation illustrated in FIGS. 1A, 1B, and 1C includes a single user device, other implementations may include a different number of user devices that utilize services provided by the cloud file provider 170.

The cloud file provider 170 is a cloud-based computing platform that provides file hosting services. The cloud file provider 170 includes file storage 180 that provides a persistent storage for files. Users can upload files from the user devices, access files stored on the cloud file provider 170 from their user devices, download instances of files stored on the cloud file provider 170 to their user devices, and/or synchronize content from local copies of files on the user devices with the cloud file provider 170. The cloud file provider 170 can limit users to accessing files that these users have updated and/or to other files which the users have been authorized to access. The cloud file provider 170 can provide additional services for generating, accessing, and/or modifying content. The cloud file provider includes a request processing unit 175 that handles requests from user devices to store files in the file storage 180, to provide instances of files from the file storage 180 to the user device 105, to provide file content and/or metadata of files in the file storage 180 to rehydrate placeholder files on the user device 105, to synchronize changes to the file content and/or metadata received from the user device 105 with the instances of the files stored in the file storage 180. The file storage 180 is a persistent storage that can include arrays of solid-state storage, hard disks, other storage mediums, or a combination thereof.

The user device 105 is a computing device that may be implemented as a portable electronic device, such as a mobile phone, a tablet computer, a laptop computer, a portable digital assistant device, a portable game console, and/or other such devices in some implementations. The user device 105 may also be implemented in computing devices having other form factors, such as a desktop computer, vehicle onboard computing system, a kiosk, a point-of-sale system, a video game console, and/or other types of computing devices in other implementations.

The user device 105 includes an application 115. The application 115 can enable users to consume, create, share, collaborate on, and/or modify various types of electronic content. The application 115 can access and/or store files in the file storage 130 of the user device 105. These files can be uploaded to the cloud file provider 170 and/or synchronized with instances of the file maintained by the cloud file provider 170.

The user device 105 also includes a file system 120 that organizes and manages files stored in the file storage 130 of the user device 105. The file system 120 can receive requests from the application 115 to access files stored in the file storage 130 and/or to store files to the file storage 130. The file storage 130 is a persistent storage on the user device 105, which may comprise solid state storage, a hard disk driver, and/or other types of persistent storage.

The user device also includes a file system filter 125. The file system filter 125 is a software driver that attaches to the software stack of the file system 120. The file system filter 125 monitors and can also modify the behavior of file input/output (I/O) operations that are performed by the file system 120. The file system filter 125 communicates with the file provider client 145 to implement the techniques as will be discussed in greater detail in the example implementations which follow. The file provider client 145 exposes a namespace of the portion of the file storage 130 that is controlled by the file provider client to the file system filter 125. This enables the file provider client 145 to determine whether a file requested by an application, such as the application 115, falls within the namespace of the file provider client 145. In some implementations, the file system filter 125 utilizes a path associated with the requested file to determine whether the requested file falls within this namespace, and the file system filter 125 requests the file from the file provider client 145 responsive to the file system filter 125 determining that the file is unavailable at the path specified in the request from the application 115 and the path falls within the namespace of the file provider client 145. If the file provider client 145 cannot locate the file, the file provider client 145 notifies the file system filter 125, and the file system filter 125 notifies the application 115 that the file cannot be found. Otherwise, the file provider client 145 may provide an instance of the file or a placeholder file to the file system filter 125 as discussed n the example implementations which follow.

The file provider client 145 communicates with the cloud file provider 170 over a network connection. The network connection can be implemented by public and/or private network connections and can be implemented at least in part by the Internet. The file provider client 145 can send requests to the cloud file provider 170 for various services provided by the cloud file provider 170. These services can include but are not limited to storing instances of files on the cloud file provider 170, obtaining file content and/or metadata associated with files stored on the cloud file provider 170 from the cloud file provider 170, searching for content stored on the cloud file provider 170. and/or requesting that the cloud file provider 170 generate content using a generative model and/or procedural generation.

The file provider client 145 implements a file mapping datastore 140 that monitors and maintains a mapping within a namespace controlled by the file provider client 145. The namespace can be represented by a tree-structured hierarchical representation of the contents of the file storage 130 maintained by the file system 120. The tree-structured hierarchical representation includes files and the respective folders or directories in which these files are stored. The file provider client 145 maintains path information for the files stored in the file storage 130 that includes a location of the file in the hierarchical directory or folder structure and a filename associated with the file. As will be discussed in greater detail in the examples which follow, the file provider client 145 uses this file path information to facilitate locating files and/or placeholder files that have been renamed or moved and/or for recreating placeholder files that have been deleted or otherwise unavailable in the file storage 130 of the user device 105.

The file provider client 145 supports retrieval of files from the cloud file provider 170 where there is not a corresponding placeholder files for these files on the user device or where the placeholder files have been moved or renamed. Current file providers require a placeholder file to be stored on the user device for files that are synchronized with an instance of the file stored on the cloud file provider and there is not an instance of the file also stored on the user device. Files in such a state are referred to herein as being “dehydrated” files because most or all of the file contents and/or the metadata associated with the file are stored on the cloud file provider 170. Files that are not currently being used or have not been used for a threshold amount of time can be dehydrated by the file provider client 145 to reduce the storage requirements on the user device 105. Furthermore, the file provider client 145 may dehydrate one or more files stored in the file storage 130 to free up storage for one or more other files that need to be rehydrated. The dehydrated files are represented by a placeholder file in the file storage 130.

The file provider client 145 monitors the activity of the file system 120 within the namespace of the file provider client 145, including creating, renaming, moving, and/or deletion of files stored in the file storage 130. The file provider client 145 maintains file path and filename information in the file mapping datastore 140, and changes made to this information over time. A technical benefit of this approach is that the file system filter 125, working in conjunction with the file provider client 145, supports requests for files from the application 115 where the application 115 is unaware that the file has been moved, renamed, or removed. For instance, the application 115 may maintain a most recently used list of files that indicate files that have most recently been accessed, created, and/or modified via the application 115. One or more of the files on the most recently used list may be moved or renamed after being added to the list but the application 115 would not be aware of this change. Consequently, when a user requests that the application 115 access one of the files the path information for that file is out of date. However, the file system filter 125 can determine that the file or a placeholder file is unavailable in the file storage 130 and instead forward the request for file to the file provider client 145. The file provider client 145 compares the file path information for the requested file with the file path information stored in the file mapping datastore 140 to determine whether the file has been renamed, moved, or removed. The file provider client 145 can determine whether there is an instance of the file, or a placeholder file associated with the file stored in the file storage 130. If no file or placeholder file exists, the file provider client 145 can create a placeholder file based on the information included in the file mapping datastore 140 and initiate a hydration request to the to obtain at least a portion of the file contents and/or metadata from the cloud file provider 170 if an instance of the file exists on the cloud file provider 170. Consequently, the application 115 would not be aware that the placeholder file or a hydrated instance of the file was unavailable on the user device 105 at the time that the application 115 requested the file. In some implementations, the file provider client 145 provides a handle or other reference to the placeholder file to the file system filter 125, and the file system filter 125 can subsequently provide a hydration request to the file provider client 145 to obtain a least a portion of the file contents of the file and/or the file metadata from the cloud file provider 170.

While the file provider client 145 utilizes the file mapping datastore 140 to maintain a mapping of the files that is stored in the file mapping datastore 140, other implementations may implement other means for tracking files in addition to and/or instead of the file mapping datastore 140. For instance, the file provider client 145 can query the cloud file provider 170 for the mapping information, and the cloud file provider 170 can implement the file mapping datastore 140 for files that fall within the namespace of the file provider client 145.

Applications on the user device 105, such as the application 115, can reference the placeholder file when performing create, read, update, or delete (CRUD) operations, and the file provider client 145 on the user device uses metadata included in the placeholder file to access the file content and/or metadata stored on the cloud file provider 170 and to perform various actions on file. These actions can include hydrating the placeholder file on the user device 105 to replace the placeholder file with an instance of the file from the cloud file provider 170. This instance of the file can include all or a portion of the file contents of the file on the cloud file provider 170 and/or additional metadata associated with the file that was not included in the placeholder file. However, the placeholder file may be deleted, moved, renamed, or be otherwise unavailable on the user device 105, resulting in the requests to perform operations on the file failing. The techniques provided herein provide a technical solution to this problem by maintaining a mapping of files within a namespace that is controlled by the file provider client 145. The file system filter 125 recognizes when the placeholder file associated with a file has been moved, renamed, deleted, or is otherwise unavailable. The file provider client 145 can create a placeholder file on the user device 105 and can perform a hydration operation to hydrate the placeholder file. A technical benefit of this approach is that applications utilizing the files that are synchronized with and/or maintained on the cloud file provider 170 can be accessed by applications on the user device 105 even where a corresponding placeholder file is unavailable. As a result, the performance of the user device 105 is improved by enabling applications to access file content for dehydrated files that would have otherwise resulted in the file system 120 reporting a file not found error to the application 115 in response to the request for the file.

FIG. 1A shows an example of two placeholder files, Placeholder File A 135a and Placeholder File B. The Placeholder File A 135a provides a placeholder for the File A 185a which has been dehydrated on the user device 105 and an instance of the File A 185a is stored in the file storage 180 of the cloud file provider 170. The Placeholder File A 135a includes metadata that can be used to identify the instance of File A 185a stored in the file storage 180 and can be used by the file provider client 145 to rehydrate File A to replace the Placeholder File A 135a in the file storage 130 with an instance of that file. Similarly, the Placeholder File B 135b provides a placeholder for the File B 185b which has been dehydrated on the user device 105 and an instance of the File B 185b is stored in the file storage 180 of the cloud file provider 170. The Placeholder File B 135b includes metadata that can be used to identify the instance of File B 185b stored in the file storage 180 and can be used by the file provider client 145 to rehydrate File B to replace the Placeholder File B 135b with an instance of that file in the file storage 130 of the user device 105.

The file storage 180 of the cloud file provider 170 also includes a File C 185c. No placeholder file or instance of the File C 185c is currently available in the file storage 130 of the user device 105. The application 115 attempts to access the File C via the file system 120. The file system filter 125 monitors I/O requests received by the file system 120 and determines whether the File C or a place holder file for File C is available in the file storage 130. The file system filter 125 determines that there is no instance of File C or placeholder file for File C in the file storage 130. The request from the application 115 includes file path information for File C. The file system filter 125 provides the request to the file provider client 145, and the file provider client 145 compares the file path information received from the application 115 with file path information stored in the file mapping datastore 140 to determine whether the File C has been renamed or moved on the user device 105. In this example, the File C has been removed from the user device 105 and there is no placeholder file. The File C may have been removed from the user device 105 by the file provider client 145 for various reasons, such as but not limited to performing a file cleanup, selective synchronization of specific files, archiving, and/or other actions for which the file provider client 145 may remove files from the user device 105. In response, the file provider client 145 obtains file path information for File C from the file mapping datastore 140. As discussed above, the file path information includes the path to the location that File C was located in the hierarchical tree-structure representation of the file system and the filename. The file path information can also include metadata that provides additional information about the file and/or the file contents. The file provider client 145 utilizes this information to create a Placeholder File C 135c as shown in FIG. 1B. The file provider client 145 may then execute a hydration request to attempt to obtain at least a portion of the file content and/or the metadata of File C from the cloud file provider 170. In some implementations, the hydration request is performed automatically in response to creating the placeholder file. In other implementations, the file provider client 145 creates the placeholder file and the application 115 and/or the file system filter 125 may then submit a hydration request to the file provider client 145 to hydrate the placeholder file. In this example, File C 185c is stored in the file storage 180 of the cloud file provider 170, and the request processing unit 175 provides at least a portion of the file content and/or metadata associated with File C to the file provider client 145. The file provider client 145 generates a hydrated version of the File C 135c from the placeholder file as shown in FIG. 1C. The file system filter 125 can then provide a handle or other reference to the File C 135c to the file system 120, which in turn provides this handle or file reference to the application 115. The application 115 can then access the File C 135c to present the content of the file on a user interface of the application 115 and/or perform other actions on the file contents and/or metadata.

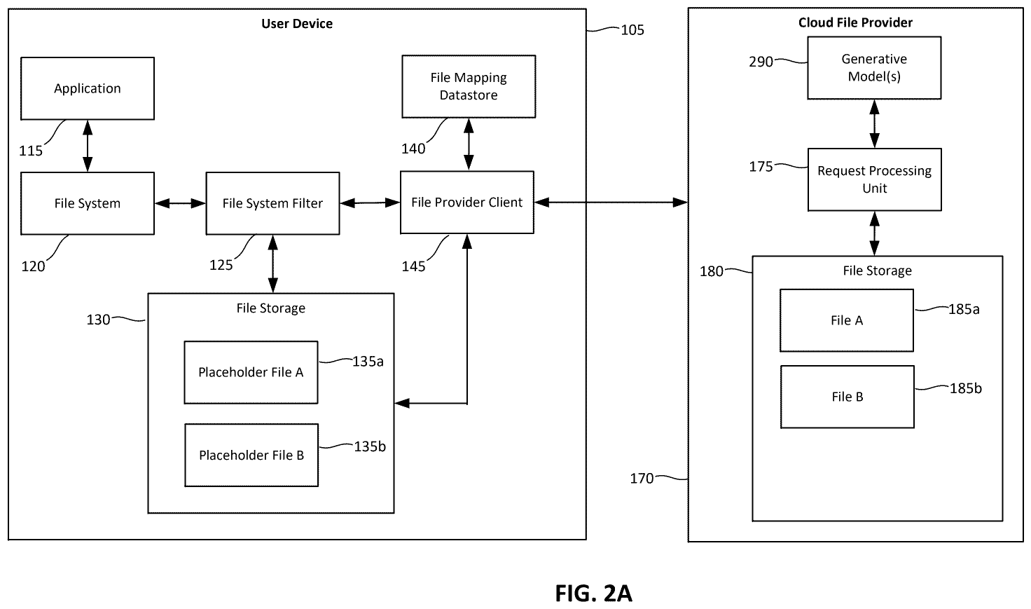

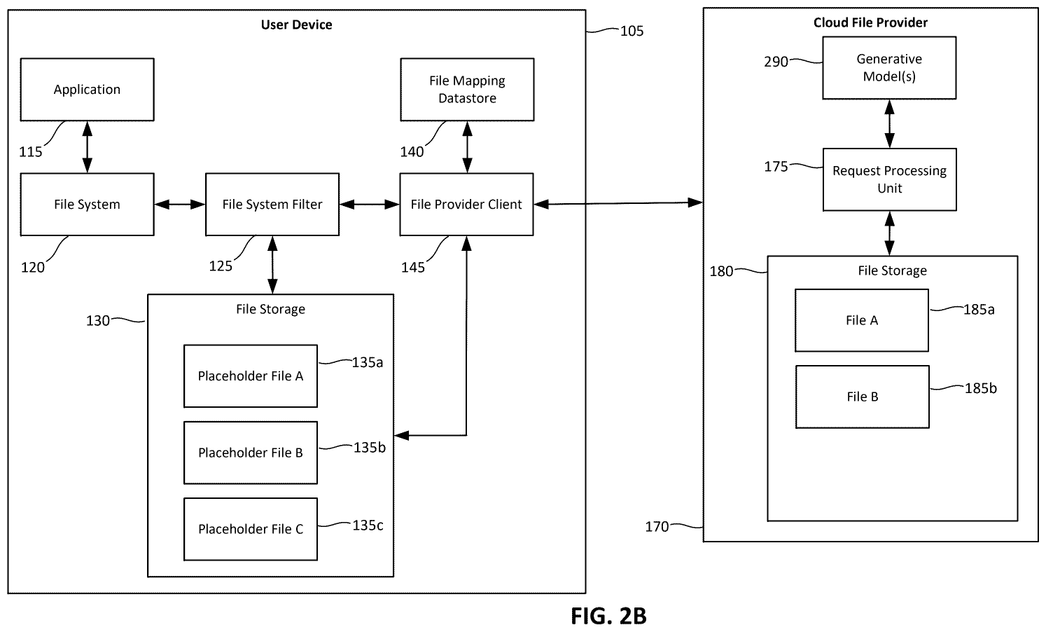

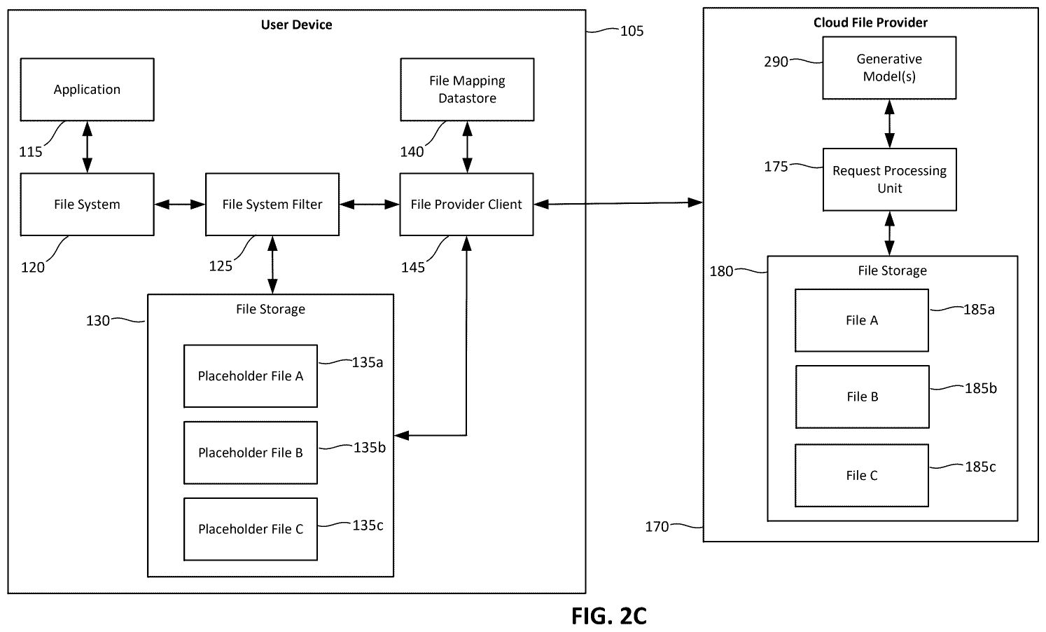

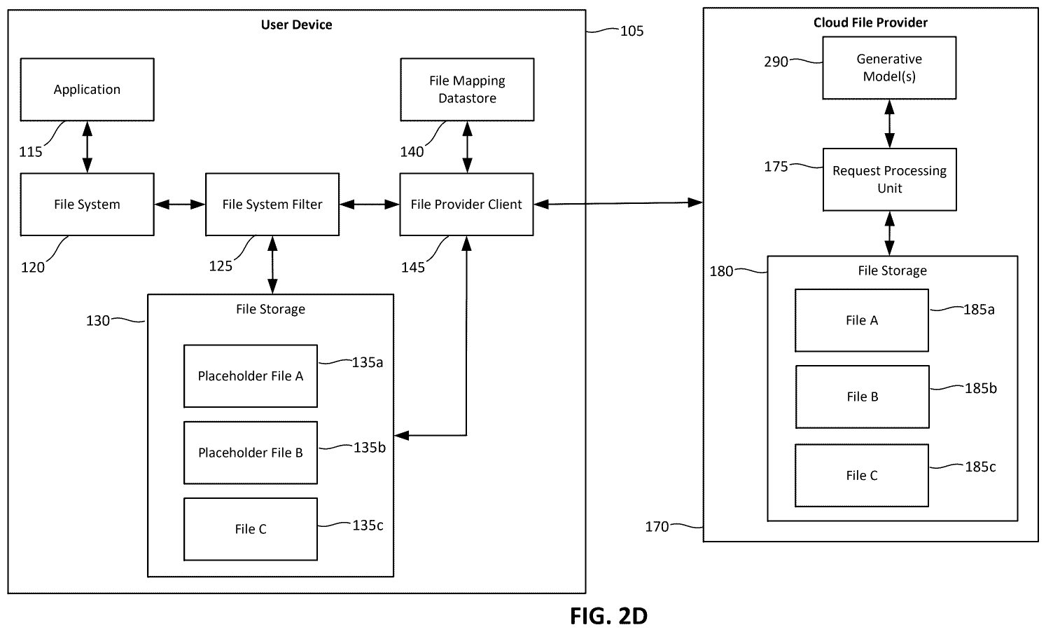

FIGS. 2A, 2B, 2C, and 2D are diagrams of an example computing environment in which the techniques for fulfilling requests for files stored on a cloud file provider for which no placeholder file is present described herein are implemented. In the example implementation shown in FIGS. 2A, 2B, 2C, and 2D, the application 115 requests the generation of content by a generative model or multiple generative models. In such implementations, the application 115 can generate a prompt to the one or more generative models to create the content and/or provide a user interface that enables a user to input a prompt to the one or more generative models to create the content. In such implementations, the application 115 can request that the file system 120 open a file for the content to be created, the request can include an indication that the file is to be generated using one or more generative models and the prompt for creating the content. The file system filter 125 monitors the software stack of the file system 120 and detects the request to generate the content using the one or more generative models. The file system filter 125 forwards the request to the file provider client 145 to create the Placeholder File C 135c in the file storage 130 of the user device 105 as shown in FIG. 2B. The Placeholder File C 135c includes an indication that the content is to be created by the one or more generative models 290 of the cloud file provider 170 and includes the prompt provided by the application 115 for creating the content. The file system filter 125 requests that the file provider client 145 hydrate the Placeholder File C 135c and the request processing unit 175 of the cloud file provider 170 submits the prompts to the one or more generative models 290. The request processing unit 175 obtains the generated content and stores the content as File C 185c shown in FIG. 2C.

The request processing unit 175 sends an indication that the File C 185c has been created to the file provider client 145 which notifies the file system filter 125 that the content has been created. The file system filter 125 can then provide a hydration request to the file provider client 145 to cause the file provider client 145 to hydrate the Placeholder File C 135c with at least a portion of the generated content from File C 185c. The hydrated File C replaces the placeholder file as shown in FIG. 2D. In other implementations, the file provider client 145 automatically hydrates the Placeholder File C 135c and provides an indication to the file system filter 125 that the File C 135c. The file system filter 125 can provide a handle or other reference to the File C 135c to the application 115 indicating that the application is available. In other implementations, the file system filter 125 does not request that the file provider client 145 until the application 115 attempts to access the file.

The one or more generative models 290 can include one or more generative models that are capable of generating various types of content in response to a textual prompt providing instructions to the model to generate the content. The one or more generative models 290 can include a large language model (LLM), such as but not limited to a Generative Pre-trained Transformer 3 (GPT-3), GPT-4, or GPT-40 model. Other implementations may utilize other models or other generative techniques to generate content in response to prompts. For instance, the cloud file provider 170 and/or other cloud service provider can generate content procedurally using a procedural content generator rather than utilizing a generative model. Procedural generation utilizes algorithms to generate content rather than relying on a model to generate the content. Procedural generation may be utilized to provide specific controls over the content that is generated and/or to reduce the computing resources required to generate the content.

In the example implementation shown in FIGS. 2A, 2B, 2C, and 2D, the one or more generative models 290 are implemented on the cloud file provider. In other implementations, the one or more generative models 290 are implemented on a separate cloud-based service, and the request processing unit 175 sends a request to create content to the separate cloud-based services with the prompt to create the requested content. The separate cloud-based service then provides the requested content to the cloud file provider 170 for storage in the file storage 180. The request processing unit 175 can also then provide an indication to the file provider client 145 that the content has been generated.

A technical benefit of this approach is that the file system filter 125 and the file provider client 145 can facilitate the creation of content using artificial intelligence and/or procedural generation means. The creation of the content by the one or more generative models 290 and/or through procedural means may take a significant amount of time. A technical benefit of this approach is that the file provider client 145 creates the placeholder file for the content while the content is being generated and the file system filter 125 can provide a handle or other reference to placeholder file to the application 115 while the content is being generated. The application 115 can then request that the file be hydrated once the content has been generated. The file system filter 125 can provide a notification to the application 115 once the content has been generated. The content can be created and stored on the cloud file provider 170 until required by the application 115 to reduce the computing and memory resources utilized on the user device 105 for storing and creating the content. Furthermore, the file provider client 145 can selectively initiate the dehydration of other content stored in the file storage 130 to ensure that there is sufficient storage available in the file storage 130 before hydrating the placeholder file for the content. This approach provides more efficient management and utilization of resources on the user device 105, which can be particularly important for user devices that are resource constrained.

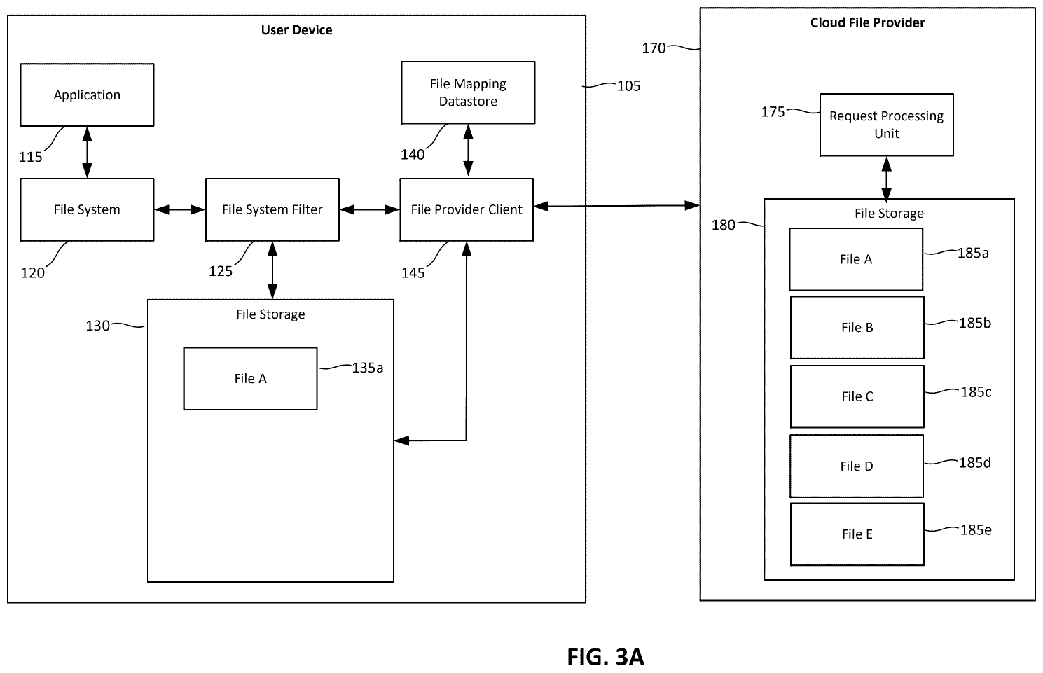

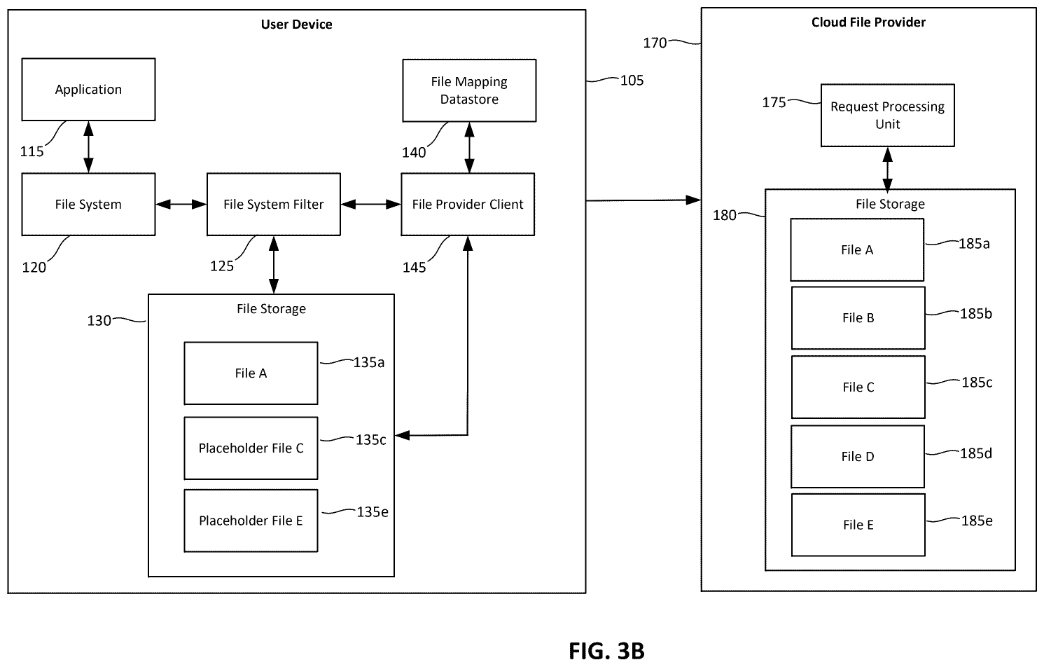

FIGS. 3A and 3B are diagrams of an example computing environment in which the techniques for fulfilling a search request for content stored on the cloud file provider 170 or both the user device 105 and the cloud file provider 170 described herein are implemented. The file system filter 125 can be used to implement federated search requests in which multiple data sources are searched. In the example implementation shown herein, these sources include files stored in the file storage 130 of the user device 105 and the file storage 180 of the cloud file provider 170. In other implementations, the additional sources can be searched in addition to or instead of the sources shown in this example. The file provider client 145 can maintain a mapping of the files in the file mapping datastore 140 in such examples.

In the example implementation shown in FIGS. 3A and 3B, the application 115 can generate a search request to the file system 120 that includes query parameters for identifying relevant files stored in the file storage 130 of the user device 105 and/or on the cloud file provider 170. The file system filter 125 monitors the I/O requests to the file system 120 of the user device 105 and handles the search request. The file system filter 125 forwards the request to the file provider client 145, and the file provider client 145 searches for relevant files stored in the file storage 130 of the user device 105. The file provider client 145 can compare the query parameters with file metadata and/or file content of the files in the file storage 130 to identify relevant files in the file storage 130 of the user device 105. The file provider client 145 also submits a second search request to the request processing unit 175 of the cloud file provider 170 to search for relevant files stored in the file storage 180 of the cloud file provider 170. The request processing unit 175 searches for relevant files in the file storage 180. The request processing unit 175 compares the query parameters with the file metadata and/or file content of the files in the file storage 180 to identify relevant files. The request processing unit 175 provides the search results for the files identified on the file storage 180 to the file provider client 145.

The file provider client 145 determines whether one or more of the files stored on the cloud file provider 170 included in the search results received from the cloud file provider 170 do not have a corresponding copy or instance of that file or placeholder file stored in the file storage 130 of the user device 105. For each of the files included in the search results received from the cloud file provider 170 that do not have a corresponding copy or placeholder file, the file provider client 145 creates a placeholder file in the file storage 130 of the client device. The file provider client 145 also adds these placeholder files to the file mapping information maintained in the file mapping datastore 140 as discussed in the preceding examples. The file provider client 145 then provides the search results from the user device 105 and the cloud file provider 170 to the file system filter 125, and the file system filter 125 provides the search results to the application 115. The application 115 may then present the search results on a user interface of the application 115 and/or perform other operations on the search results. A technical benefit of this approach is that the search results can be rapidly provided to the application 115 without delaying the presentation of the search results while instances of the files included in the search results are hydrated on the user device 105. Downloading the files included in the search results obtained from the cloud file provider 170 may be prohibitively time consuming and utilize significant computing and memory resources of the user device 105 and/or the cloud file provider 170, and network resources to transmit the data from the cloud file provider 170 to the user device 105 depending on size of the files and/or the number of files included in the search results. The file system filter 125 and the file provider client 145 provide a technical solution to the problem of efficiently presenting the search results to the application 115 by creating placeholder files for each of the search results that are not already stored in the file storage 130 of the user device 105. The user of the application 115 and/or the application 115 may determine that only a subset of the files included in the search results obtained from the cloud file provider 170 are relevant further analysis and access just these files. The individual placeholder files related to the selected files can then be hydrated in response to requests from the application 115 for additional information about these files. Consequently, the computing, memory, and network resources needed to provide the search results to the application 115 can be significantly reduced.

FIG. 3A shows an example in which the file storage 130 of the user device 105 includes File A 135a and the file storage 180 of the cloud file provider 170 includes files File A 185a, File B 185b, File C 185c, File D 185d, and File E 185e. In this example, the user submits a search request. The file provider client 145 determines that File A 135a is relevant based on the query parameters, and the request processing unit 175 determines that File A 185a, File C 185c, and File E 185e are relevant based on the query parameters. The search results from the cloud file provider 170 are provided to the file provider client 145, and the file system filter 125 determines that File C 185c and File E 185e do not have a corresponding file instance of placeholder file stored in the file storage 130 of the user device 105. The file provider client 145 then creates Placeholder File C 135c and Placeholder File E 135e for these two files in the file storage 130 as shown in FIG. 3B. These placeholder files can then be hydrated in response to a request from the application 115. In other implementations, at least a portion of the placeholder files may be automatically hydrated by the file provider client 145.

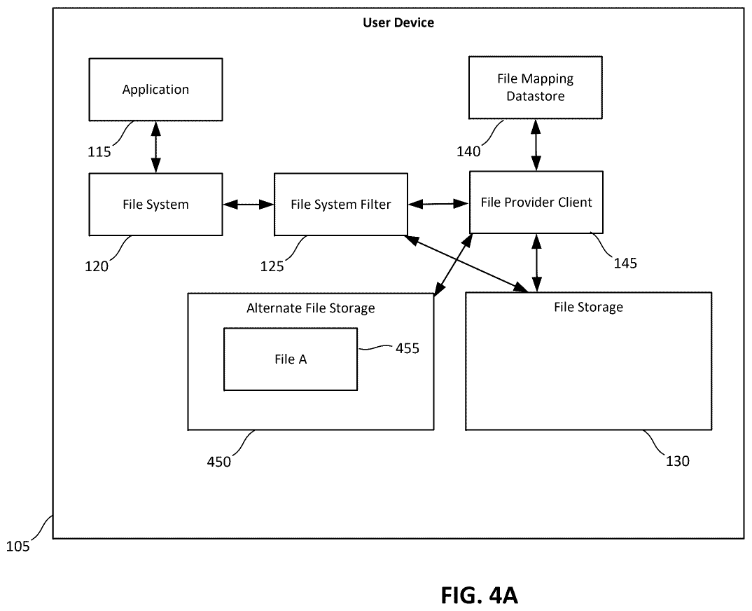

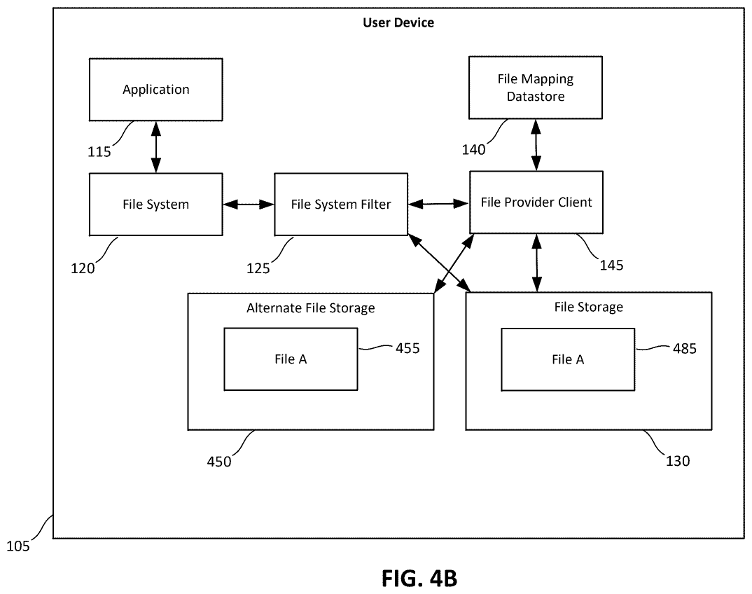

FIGS. 4A and 4B are diagrams of an example computing environment in which the techniques for fulfilling requests for files cached on a user device described herein are implemented. In the example implementation shown in FIGS. 4A and 4B, the user device 105 does not rely on the cloud file provider 170 shown in the preceding examples to synchronize file content. Instead, the file provider client 145 is configured to manage storage of files in the file storage 130 and/or other storage of the user device 105.

The file system filter 125 monitors I/O operations to the file system in this example embodiment in a similar manner as discussed in the preceding examples. The file provider client 145 stores file mapping information that is stored in the file mapping datastore 140. The file provider client 145 tracks files that are created, moved, renamed, or removed from the file storage 130. The user device 105 also includes alternate file storage 450 which provides an alternate memory on the user device 105 in which a file may be stored. For instance, the alternate file storage 450 can be a cache that is used to improve I/O operations by storing certain data in system memory that is quicker to access and/or update than the file storage 130. The alternate file storage 450 can also be used to implement other types of storage on the user device 105, such as but not limited to a removable storage device. The file provider client 145 monitors I/O operations of the file system 120 maps operations that copy files from the file storage 130 to the alternate file storage 450 so that subsequent requests for a file from the file storage 130 can be served with instances of the file from the alternate file storage 450.

In the example implementation shown in FIGS. 4A and 4B, the application 115 requests access to a File A from the file storage 130. As discussed in the preceding examples, an instance of the file may have been moved, renamed, or deleted from the file storage 130 for various reasons, including but not limited to a file cleanup freeing up space in the file storage 130 or archiving files from the file storage 130 to the alternate file storage 450. The file system filter 125 cannot locate an instance of the file in the file storage 130 and forwards the request for the file to the file provider client 145. In FIG. 4A, File A is unavailable in the file storage 130. The application 115 may have attempted to access File A using outdated most recently used file information or otherwise outdated file information. However, the file provider client 145 determines, based on the file mapping datastore 140, an instance of File A 455 was copied or moved to the alternate file storage 450. The file provider client 145 can then create an instance of File A 485 in the file storage 130. Alternatively, the file provider client 145 can create a placeholder file in the file storage 130 that indicates that an instance of File A 455 is available in the alternate file storage 450 and the file system filter 125 redirects the I/O operations to utilize this instance of the File A 455. The file system filter 125 can provide an indication that the file has been moved or renamed and is available in the alternate file storage 450 to the application 115 before utilizing the instance of the file in the alternate file storage 450.

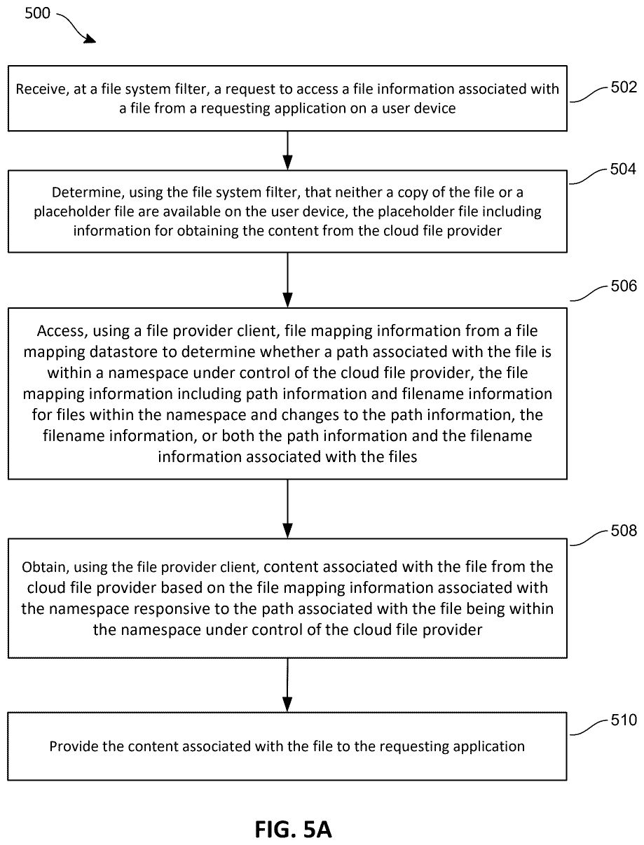

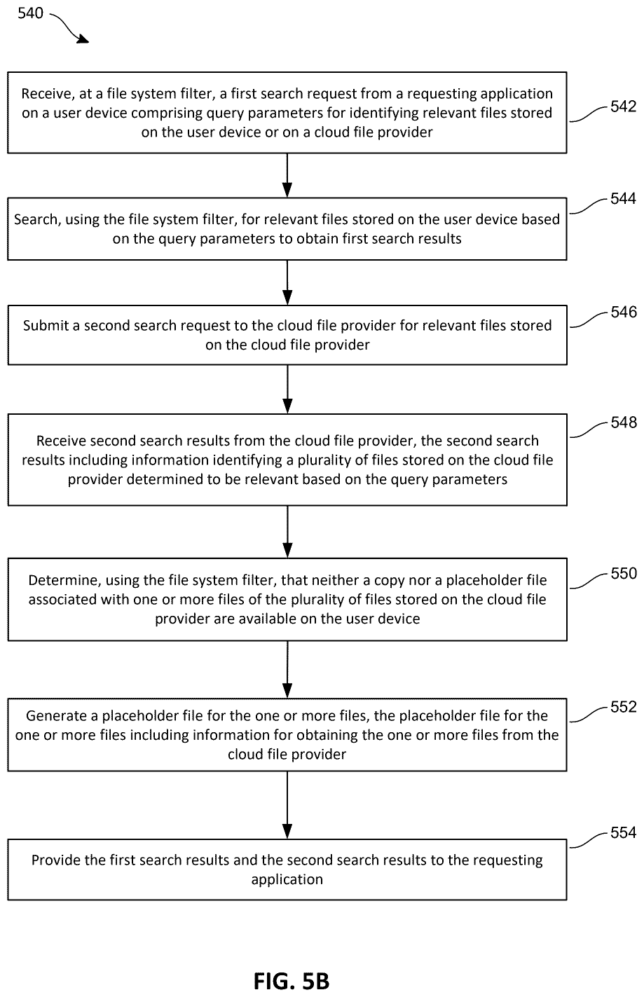

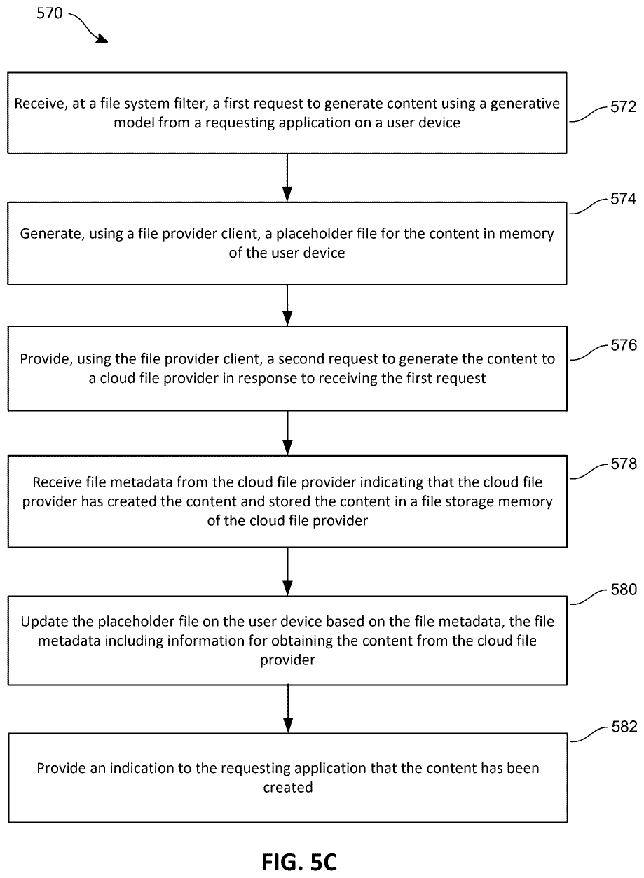

FIG. 5A is a flow chart of an example process for processing requests for files from an application on a user device according to the techniques disclosed herein. As discussed in the preceding examples, the process 500 can be implemented by the file system filter 125 and the file provider client 145 shown in FIGS. 1A and 1B.

The process 500 includes an operation 502 of receiving, at a file system filter 125, a request to access a file information associated with a file from a requesting application on a user device. The file system filter 125 monitors I/O requests to the file system 120. The requesting application can be implemented by the application 115.

The process 500 includes an operation 504 of determining, using the file system filter 125, that neither a copy of the file nor a placeholder file are available on the user device 105. As discussed in the preceding examples, the placeholder file indicates how a copy of the file can be obtained from a cloud file provider 170 and can contain metadata and/or other information that the file provider client 145 and/or the request processing unit 175 can use to determine which file is being requested.

The process 500 includes an operation 506 of accessing, using a file provider client 145, file mapping information from a file mapping datastore to determine whether a path associated with the file is within a namespace under control of the file provider client 145, the file mapping information including path information and filename information for files within the namespace and changes to the path information, the filename information, or both the path information and the filename information associated with the files. The file provider client 145 maintains file mapping information in the file mapping datastore 140 to track the files in the file storage of the user device 105. The file provider client 145 tracks when files are moved and/or renamed and stores the old and new path information and/or filenames in the file mapping datastore 140 to facilitate locating files for which the placeholder file has been moved, rename, deleted, or is otherwise unavailable in the file storage 130 of the user device 105. The application 115 may be unaware that these actions have taken place and may reference the placeholder file using an out-of-date path and/or file name.

The process 500 includes an operation 508 of obtaining content associated with the file from the cloud file provider based on the file mapping information associated with the namespace responsive to the path associated with the file being within the namespace under control of the cloud file provider. In some implementations, the file provider client 145 creates a placeholder file in the file storage 130 and executes file hydration request to the cloud file provider 170 to generate a hydrated instance of the file in the file storage 130. The hydrated version of the file can include at least a portion of the file content and/or metadata from the file instance stored on the cloud file provider 170. In other implementations, the file provider client 145 obtains an instance of the file from the cloud file provider 170 and stores the instance of the file in the file storage 130 of the user device 105 without creating the placeholder file. The instance of the file can include all or a portion of the file content and/or metadata associated with the file instance stored on the cloud file provider 170.

The process 500 includes an operation 510 of providing the content associated with the file to the requesting application. The requesting application can be implemented by the application 115. The file system filter 125 can provide a handle or other reference to the file to the application 115 that enables the application to access the file. In the example shown in FIG. 1C, the File C 135c is the hydrated file instance generated by the file provider client 145 after the file system filter 125 created the Placeholder File C based on the file mapping information from the file mapping datastore 140.

FIG. 5B is a flow chart of another example process 540 for processing requests for files from an application 115 on a user device 105 according to the techniques disclosed herein. As discussed in the preceding examples, the process 540 can be implemented by the file system filter 125 and the file provider client 145 shown in FIGS. 3A and 3B. The process 540 can be used to implement federated search requests in which multiple data sources are searched. In the example implementation shown herein, these sources include files stored in the file storage 130 of the user device 105 and the file storage 180 of the cloud file provider 170. In other implementations, the additional sources can be searched in addition to or instead of the sources shown in this example. The file system filter 125 can maintain a mapping of the files in the file mapping datastore 140 in such examples.

The process 540 includes an operation 542 of receiving, at a file system filter 125, a first search request from a requesting application on a user device comprising query parameters for identifying relevant files stored on the user device or on a cloud file provider. The application 115 can provide the search request to the file system 120 and the file system filter 125 detects and processes this search request.

The process 540 includes an operation 544 of searching, using a file provider client 145, for relevant files stored on the user device based on the query parameters to obtain first search results. The file provider client 145 searches for files stored in the file storage 130 of the user device 105.

The process 540 includes an operation 546 of submitting a second search request to the cloud file provider 170 for relevant files stored on the cloud file provider 170. The file system filter 125 provides the search request to the file provider client 145, and the file provider client 145 provides the search request to the request processing unit 175 of the cloud file provider 170 for processing. The request processing unit 175 compares the query parameters to the file metadata and/or file contents of the files in the file storage 180 to identify relevant files in the file storage 180.

The process 540 includes an operation 548 of receiving second search results from the cloud file provider 170. The second search results include information identifying a plurality of files stored on the cloud file provider 170 determined to be relevant based on the query parameters. The request processing unit 175 provides the second search results to the file provider client 145. The file provider client 145 can also provide the second search results to the file system filter 125.

The process 540 includes an operation 550 of determining, using the file provider client 145, that neither a copy nor a placeholder file associated with one or more files of the plurality of files stored on the cloud file provider are available on the user device 105. The file provider client 145 determines whether each of the search results from the cloud file provider 170 have a corresponding placeholder file or file instance in the file storage 130 of the user device 105.

The process 540 includes an operation 552 of generating a placeholder file for the one or more files including information for obtaining the one or more files from the cloud file provider 170. The file provider client 145 creates placeholder files for each of the files from the search results that did not include a corresponding placeholder file or file instance in the file storage 130 of the user device 105.

The process 540 includes an operation 554 of providing the first search results and the second search results to the requesting application. The file system filter 125 provides the search results from the user device 105 and the cloud file provider 170 to be presented on a user interface of the application 115 and/or for further processing. This approach provides a technical solution to the problem of efficiently presenting the search results to the application 115 by creating placeholder files for each of the search results that are not already stored in the file storage 130 of the user device 105. The user of the application 115 and/or the application 115 may determine that only a subset of the files included in the search results obtained from the cloud file provider 170 are relevant further analysis and access just these files. The individual placeholder files related to the selected files can then be hydrated in response to requests from the application 115 for additional information about these files. Consequently, the computing, memory, and network resources needed to provide the search results to the application 115 can be significantly reduced.

FIG. 5C is a flow chart of another example process 570 for processing requests for files from an application on a user device 105 according to the techniques disclosed herein.

As discussed in the preceding examples, the process 570 can be implemented by the file system filter 125 and the file provider client 145 shown in FIGS. 2A-2B.

The process 570 includes an operation 572 of receiving, at a file system filter, a first request to generate content using a generative model from a requesting application on a user device. As discussed in the preceding examples, the request to create the content can include a prompt for one or more generative models and/or procedural generation algorithms to generate content. The prompt can be a prompt that is generated by the application 115 and/or input by a user of the application 115.

The process 500 includes an operation 574 of generating a placeholder file for the content in memory of the user device. The file provider client 145 creates a placeholder file in the file storage 130 of the user device 105. The file provider client 145 can also update the file mapping datastore 140 to map the path and filename of the placeholder file with the request to create the content received from the application 115. This mapping can be used should the placeholder file be moved, renamed, deleted, and/or otherwise become unavailable. As discussed in the preceding examples, the mapping information maps files that are within the namespace controlled by the file provider client 145. The file provider client 145 can expose this namespace information to the file system filter 125 to enable the file system filter 125 to determine whether a file or placeholder file exists within the file system 120 within the namespace managed by the file provider client 145.

The process 500 includes an operation 576 of providing, using a file provider client 145, a second request to generate the content to a cloud file provider in response to receiving the first request. The file system filter 125 provides the request and the prompt to the file provider client 145 which provides the request and the prompt to the request processing unit 175 of the cloud file provider 170.

The process 500 includes an operation 578 of receiving file metadata from the cloud file provider indicating that the cloud file provider has created the content and stored the content in a file storage memory of the cloud file provider. The request processing unit 175 submits the prompt received from the user device 105 to the one or more generative models 290 to obtain the requested content. The request processing unit 175 then stores the content in the file storage 180 of the cloud file provider 170.

The process 500 includes an operation 580 of updating the placeholder file on the user device based on the file metadata with the file metadata which includes information for obtaining the content from the cloud file provider 170. The file system filter 125 and/or the file provider client 145 can update the placeholder file with the metadata.

The process 500 includes an operation 582 of providing an indication to the requesting application that the content has been created. The file system filter 125 can provide a file handle or other reference to the placeholder file to the application 115. The application 115 can also be provided with the file handle or the placeholder file in operation 576 and the application is then notified once the content has been generated. In some implementations, the generative models may take a significant amount of time to generate the requested content and/or the requested content may require a significant amount of storage. In such implementations, the generated content may be stored on the cloud file provider 170 until a hydration request is received from the file system filter 125. A technical benefit of this approach is that the file storage 130 of the client device can be more effectively managed. The file provider client 145 can dehydrate one or more files stored in the file storage 130 of the user device 105 to ensure that there is sufficient storage available in the file storage 130 before attempting to dehydrate including the generated content.

The detailed examples of systems, devices, and techniques described in connection with FIGS. 1A-5C are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1A-5C are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.” Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

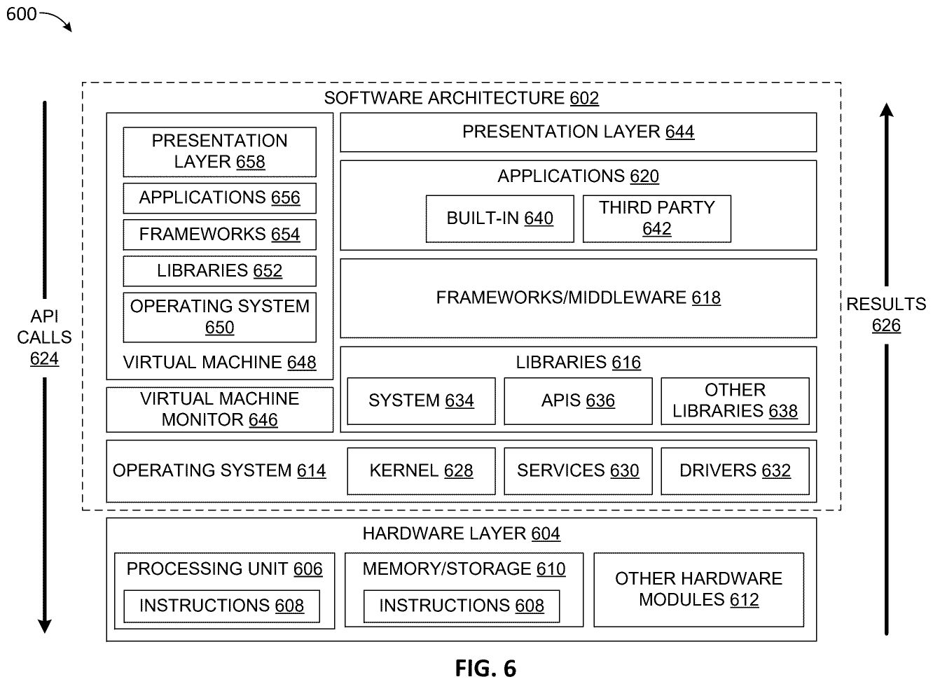

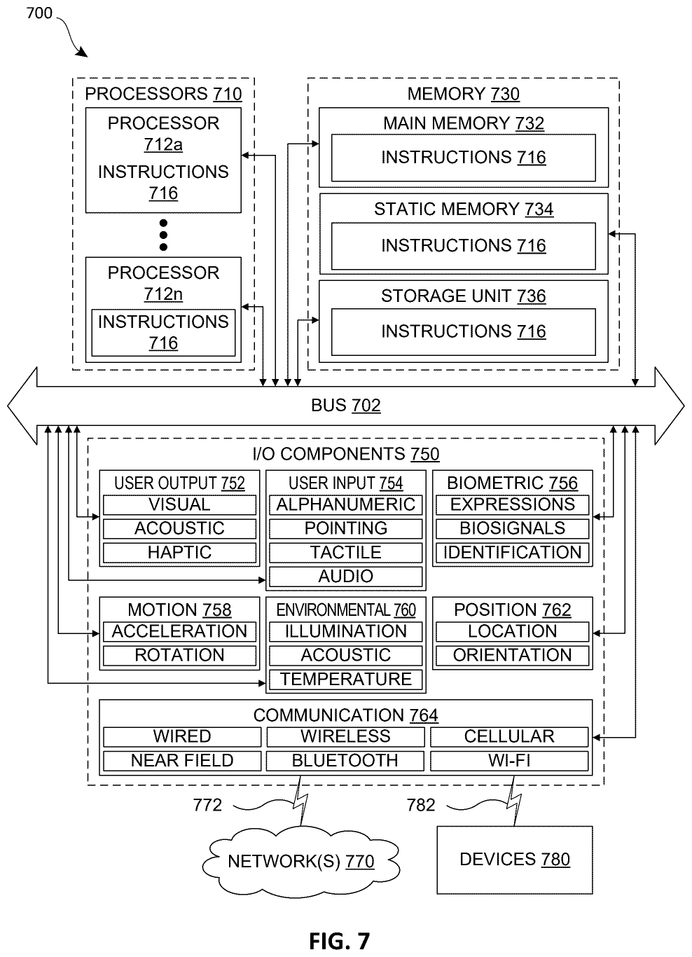

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory/storage, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks/middleware 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks/middleware 618 provide a higher-level common infrastructure that may be used by the applications 620 and/or other software modules. For example, the frameworks/middleware 618 may provide various graphic user interface (GUI) functions, high-level resource management, or high-level location services. The frameworks/middleware 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks/middleware 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory/storage 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multicore processor including cores that may execute instructions contemporaneously. Although FIG. 7 shows multiple processors, the machine 700 may include a single processor with a single core, a single processor with multiple cores (for example, a multicore processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings.

However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible.

Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a memory storing executable instructions that, when executed, cause the processor alone or in combination with other processors to perform operations of:
receiving, at a file system filter, a request to access a file information associated with a file from a requesting application on a user device;
determining, using the file system filter, that neither a copy of the file or a placeholder file are available on the user device, the placeholder file indicating how a copy of the file can be obtained from a cloud file provider;
accessing, using a file provider client, file mapping information from a file mapping datastore to determine whether a path associated with the file is within a namespace under control of the cloud file provider, the file mapping information including path information and filename information for files within the namespace and changes to the path information, the filename information, or both the path information and the filename information associated with the files;
obtaining, using the file provider client, content associated with the file from the cloud file provider based on the file mapping information associated with the namespace responsive to the path associated with the file being within the namespace under control of the cloud file provider; and
providing the content associated with the file to the requesting application.

2. The data processing system of claim 1, wherein obtaining the content associated with the file from the cloud file provider further comprises:
generating a placeholder file including information for obtaining the content from the cloud file provider, the placeholder file comprising metadata associated indicating where the file is stored on the cloud file provider.

3. The data processing system of claim 2, wherein the memory further includes instructions configured to cause the processor alone or in combination with other processors to perform operations of:
providing a file hydration request to the file provider client on the user device to cause the file provider client to obtain at least a portion of file contents of a first instance of the file maintained by cloud file provider and to replace the placeholder file on the user device with a second instance of the file that includes the at least a portion of the file contents of the file.

4. The data processing system of claim 2, wherein the memory further includes instructions configured to cause the processor alone or in combination with other processors to perform operations of:
providing a file hydration request to the file provider client on the user device to cause the file provider client to obtain metadata associated with a first instance of the file maintained by cloud file provider and to update the placeholder file on the user device with the metadata.

5. The data processing system of claim 2, wherein the memory further includes instructions configured to cause the processor alone or in combination with other processors to perform operations of:
determining, based on the path associated with the file, that the file has been moved to a new path or renamed to a new name; and
determining, using the file provider client, whether a copy of the file or a placeholder file at the new path or renamed to the new name is available on the user device.

6. The data processing system of claim 5, wherein the memory further includes instructions configured to cause the processor alone or in combination with other processors to perform operations of:
responsive to determining that a copy of the file or the placeholder file is unavailable, generating the placeholder file including information for obtaining the content from the cloud file provider.

7. The data processing system of claim 5, wherein the memory further includes instructions configured to cause the processor alone or in combination with other processors to perform operations of:
providing a file hydration request to the file provider client on the user device to cause the file provider client to obtain at least a portion of file contents of a first instance of the file maintained by cloud file provider and to replace the placeholder file on the user device with a second instance of the file that includes the at least the portion of the file contents of the file.

8. The data processing system of claim 5, wherein the memory further includes instructions configured to cause the processor alone or in combination with other processors to perform operations of:
registering the file within the namespace under control of the file provider client.

9. A method comprising:
receiving, at a file system filter, a first search request from a requesting application on a user device comprising query parameters for identifying relevant files stored on the user device or on a cloud file provider;
searching, using a file provider client, for relevant files stored on the user device based on the query parameters to obtain first search results;
submitting, using the file provider client, a second search request to the cloud file provider for relevant files stored on the cloud file provider;
receiving second search results from the cloud file provider, the second search results including information identifying a plurality of files stored on the cloud file provider determined to be relevant based on the query parameters;
determining, using the file system filter, that neither a copy nor a placeholder file associated with one or more files of the plurality of files stored on the cloud file provider are available on the user device;
generating a placeholder file for the one or more files indicating where the one or more files can be obtained from the cloud file provider; wherein the placeholder file is generated without downloading file content of the one or more files; and
providing the first search results and the second search results to the requesting application.

10. The method claim 9, further comprising:
updating a registration maintained by the file system filter to include information for each of the one or more files.

11. The processors method of claim 9, further comprising:
providing a file hydration request to a file provider client on the user device to cause the file provider client to obtain at least a portion of file contents of the one or more files; and
replacing the placeholder file associated with each of the one or more files with an instance of the one or more files.

12. (canceled)

13. The method of claim 9, further comprising:
providing a file hydration request to a file provider client on the user device to cause the file provider client to obtain metadata associated with one or more files from the cloud file provider and to update, on the user device, the placeholder file associated with each of the one or more files with the metadata.

14. (canceled)

15. A data processing system comprising:
a processor; and
a memory storing executable instructions that, when executed, cause the processor alone or in combination with other processors to perform operations of:
receiving, at a file system filter, a first request to generate content from a requesting application on a user device;
generating a placeholder file for the content in memory of the user device;
providing, using a file provider client, a second request to generate the content to a cloud file provider in response to receiving the first request;
receiving file metadata from the cloud file provider indicating that the cloud file provider has created the content and stored the content in a file storage memory of the cloud file provider;
updating the placeholder file on the user device based on the file metadata, the file metadata including information for obtaining the content from the cloud file provider; and
providing an indication to the requesting application that the content has been created.

16. The data processing system of claim 15, wherein the memory further includes instructions configured to cause the processor alone or in combination with other processors to perform operations of:
receiving, at the file system filter, a third request to obtain the content stored on the cloud file provider;
providing a file hydration request to a file provider client on the user device to cause the file provider client to obtain at least a portion of the content stored on the cloud file provider;
replace the placeholder file on the user device with a file that includes the at least the portion of the content; and
providing the at least the portion of the content to the requesting application.

17. The data processing system of claim 15, wherein the memory further includes instructions configured to cause the processor alone or in combination with other processors to perform operations of:
updating a registration maintained by the file system filter to include information for a file that includes the at least a portion of the content.

18. The data processing system of claim 15, wherein the memory further includes instructions configured to cause the processor alone or in combination with other processors to perform operations of:
receiving with the first request a prompt for a generative model to generate the content; and
providing the prompt to the cloud file provider to provide as an input to a generative artificial intelligence model to generate the content.

19. The data processing system of claim 15, wherein the memory further includes instructions configured to cause the processor alone or in combination with other processors to perform operations of:
receiving with the first request a prompt to procedurally generate the content via a defined algorithm or multistep process; and
providing the prompt to the cloud file provider to provide as an input to a procedural content generator to generate the content.

20. The data processing system of claim 15, wherein the memory further includes instructions configured to cause the processor alone or in combination with other processors to perform operations of:
determining that a placeholder file associated with the content has been moved or renamed; and
responsive to determining that a copy of a file including the content or the placeholder file has been moved or renamed, generating the placeholder file including information for obtaining the content from the cloud file provider.

21. The data processing system of claim 18, wherein the prompt comprises information input through the requesting application, including one or more of: a string of words, a set of data, a set of instructions, or file mapping information for additional files accessible within the file system filter, to be used by the generative model as source data or further detailed instruction to further refine output of the generative model.

22. The data processing system of claim 19, wherein the prompt comprises information input through the requesting application, including one or more of: data sets, strings of words, or file mapping information for additional files accessible within the file system filter to be used by the procedural content generator as source data or further detailed instructional information to further refine output of the procedural content generator.
